(19) United States
(12) Patent Application Publication
(10) Pub. No.: US 2024/0370320 A1
(43) Pub. Date: Nov. 7, 2024

(54) SYSTEM, METHOD, AND COMPUTER PROGRAM FOR ENHANCED ATTRIBUTION ASSIGNMENT TO AN APPLICATION

(71) Applicant: JPMorgan Chase Bank, N.A., New York, NY (US)

(72) Inventor: Ian Gareth ANGUS, Mercer Island, WA (US)

(73) Assignee: JPMorgan Chase Bank, N.A., New York, NY (US)

(21) Appl. No.: 18/638,085

(22) Filed: Apr. 17, 2024

Related U.S. Application Data
(60) Provisional application No. 63/464,360, filed on May 5, 2023.

(51) Int. Cl. G06F 9/54; G06F 11/34

(52) U.S. Cl. CPC G06F 9/542; G06F 11/3409

(57) ABSTRACT

Various methods, apparatuses/systems, and media for automating sponsored-search data pipelines are disclosed. A processor instruments a system at an operating system level based on implementing an instrumentation probe from a set of custom instrumentation probes; generates a chain of responsibility process tree based on instrumenting the system at the operating system level and a collected data from desired administration domain. The processor also maps corresponding operating system level process to a direct or indirect parent process that is assigned as an entry point for a logical application among a plurality of logical applications by implementing the chain of responsibility process tree; and assigns, in response to mapping, attribution data to the logical application.

### CROSS-REFERENCE TO RELATED APPLICATIONS

This application claims the benefit of priority from U.S. Provisional Patent Application No. 63/464,360, filed May 5, 2023, which is herein incorporated by reference in its entirety.

### TECHNICAL FIELD

This disclosure generally relates to data processing, and, more particularly, to methods and apparatuses for implementing a platform, cloud, and language agnostic attribution data assignment module for collecting attribution data and enhanced attribution assignment to an application for externally observed usage of cryptography.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Today, a wide variety of business functions are commonly supported by software applications and tools, i.e., business intelligence (BI) tools. For instance, software has been directed to data monitoring, performance analysis, project tracking, and competitive analysis, to name but a few. On a typically corporate computing system there may be several logical applications that may likely have different, and organizationally unrelated, owners. Each of these applications may in turn spawn dependent processes that carry out operations on behalf of that owner.

Conventional tools that scan for cryptography usage may not provide information that may enable a user to identify which application was responsible for the usage. For example, a network trace might tell one which host used a cryptographic item but could not distinguish which of the other multiple of applications on that host (each with a distinct product owner) was responsible. This may be especially challenging on container platforms (such as Kubernetes platforms) where the number of applications on a system is still comparatively large. Thus, a net result may be that it may prove to be very difficult to address observed problems because one cannot identify the responsible party be it an internal organizational application owner or the product owner for a vendor software package.

Thus, there is a need for an advanced tool that, when a monitoring system observes an event of interest (i.e., the use of a cryptographic material) by an individual process, can assign the event to the correct (logical application) owner.

### SUMMARY

The present disclosure, through one or more of its various aspects, embodiments, and/or specific features or sub-components, provides, among other features, various systems, servers, devices, methods, media, programs, and platforms for implementing a platform, cloud, and language agnostic attribution data assignment module for collecting attribution data and assigning the attribution data to an application for externally observed usage of cryptography, but the disclosure is not limited thereto.

For example, the present disclosure, through one or more of its various aspects, embodiments, and/or specific features or sub-components, may also provide, among other features, various systems, servers, devices, methods, media, programs, and platforms for implementing a platform, cloud, and language agnostic attribution data assignment module that may be configured to non-invasively instrument a system at an operating system (OS) level in order to capture a “chain of responsibility” process tree and utilize the “chain of responsibility” process tree to map any OS level process to a direct or indirect parent process that is assigned as the entry point for a logical application, thereby identifying the owner in a way that may be unique to each administration domain, but the disclosure is not limited thereto.

For example, the data assignment module that may be configured to non-invasively instrument a system at an operating system (OS) level in order to allow a first party to delegate responsibility to a next party and so on, thereby one can follow the chain of delegation back to the originator. That is, each process inherits its parent information so that if the parent predeceases the child, the parent's information is retained. Moreover, according to exemplary embodiments, the responsibility does not correspond to user accounts—as delegation can cross account boundaries.

Moreover, the attribution data assignment module, according to exemplary embodiments, may be configured to: utilize this map to attribute any file access, network communication, or system call to a specific responsible logical application; follow the potential uses of cryptography by logical applications by following the flows of cryptographic data withing the system; identify applications that might be using cryptography and, if desired, automatically instrument them to understand exactly what they might be doing, but the disclosure is not limited thereto.

According to exemplary embodiments, a method for assigning attribution data to an application by utilizing one or more processors along with allocated memory is disclosed. The method may include: implementing a set of custom instrumentation probes to collect data; instrumenting the system at an operating system level based on implementing an instrumentation probe from said set of custom instrumentation probes; receiving a subset of operating system, network, and application events data corresponding to a system in connection with the set of custom instrumentation probes; generating a chain of responsibility process tree based on instrumenting the system at the operating system level and the collected data, wherein the chain of responsibility process tree traces a flow of data in the system; mapping corresponding operating system level process to a direct or indirect parent process that is assigned as an entry point for a logical application among a plurality of logical applications by implementing the chain of responsibility process tree; and assigning, in response to mapping, attribution data to the logical application.

According to exemplary embodiments, each of the logical applications has different and organizationally unrelated owners and implements dependent processes that carry out operation on behalf of a corresponding owner, but the disclosure is not limited thereto. For example, the designated owners (or administration domains) may be distinct from and have no relationship to any operating system definition of owners and security domains.

According to exemplary embodiments, the attribution data may correspond to data that identifies an owner of the logical application in a way this is unique to each administration domain or line of business, but the disclosure is not limited thereto.

According to exemplary embodiments, when it is determined that a new process is scheduled, the method may further include: retrieving a tag for a parent process from the chain of responsibility process tree; storing the tag indexed by the new process along with a tag identifier onto a memory; and utilizing the tag identifier by accessing the memory to identify a corresponding application and determining what the system is processing. According to exemplary embodiments, the term “tag” could be more than just a tag. For example, the tag might be a whole collection of data items without departing from the scope of the present disclosure.

According to exemplary embodiments, the method may further include detecting behaviors or actions by monitoring the chain of responsibility process tree so that the behaviors or actions can be ascribed to a specific party responsible for the behaviors or actions thereby identifying on whose behalf the behaviors or actions were taken. Thus, according to exemplary embodiments, the method may further include: detecting an unauthorized behavior by monitoring the flow of data in the system; and attributing any file access, network communication, and/or system call to the logical application that is responsible for the unauthorized behavior.

According to exemplary embodiments, the method may further include: identifying applications among the logical applications that are using cryptography; automatically instrumenting the identified applications at the operating system level based on implementing the instrumentation probe from said set of custom instrumentation probes; and automatically monitoring activities of the identified applications.

According to exemplary embodiments, the method may further include: implementing configurable filtering to reduce amount of data collected that need to be sent for off system processing.

According to exemplary embodiments, a system for assigning attribution data to an application is disclosed. The system may include: a processor; and a memory operatively connected to the processor via a communication interface, the memory storing computer readable instructions, when executed, may cause the processor to: implement a set of custom instrumentation probes to collect data; instrument the system at an operating system level based on implementing an instrumentation probe from said set of custom instrumentation probes; receive a subset of operating system, network, and application events data corresponding to a system in connection with the set of custom instrumentation probes; generate a chain of responsibility process tree based on instrumenting the system at the operating system level and the collected data, wherein the chain of responsibility process tree traces a flow of data in the system; map corresponding operating system level process to a direct or indirect parent process that is assigned as an entry point for a logical application among a plurality of logical applications by implementing the chain of responsibility process tree; and assign, in response to mapping, attribution data to the logical application.

According to exemplary embodiments, when it is determined that a new process is scheduled, the processor may be further configured to: retrieve a tag for a parent process from the chain of responsibility process tree; store the tag indexed by the new process along with a tag identifier onto a memory; and utilize the tag identifier by accessing the memory to identify a corresponding application and determine what the system is processing.

According to exemplary embodiments, the processor may be further configured to detect behaviors or actions by monitoring the chain of responsibility process tree so that the behaviors or actions can be ascribed to a specific party responsible for the behaviors or actions thereby identifying on whose behalf the behaviors or actions were taken. Thus, according to exemplary embodiments, the processor may be further configured to: detect an unauthorized behavior by monitoring the flow of data in the system; and attribute any file access, network communication, and/or system call to the logical application that is responsible for the unauthorized behavior.

According to exemplary embodiments, the processor may be further configured to: identify applications among the logical applications that are using cryptography; automatically instrument the identified applications at the operating system level based on implementing the instrumentation probe from said set of custom instrumentation probes; and automatically monitor activities of the identified applications.

According to exemplary embodiments, the processor may be further configured to: implement configurable filtering to reduce amount of data collected that need to be sent for off system processing.

According to exemplary embodiments, a non-transitory computer readable medium configured to store instructions for assigning attribution data to an application is disclosed. The instructions, when executed, may cause a processor to perform the following: implementing a set of custom instrumentation probes to collect data; instrumenting the system at an operating system level based on implementing an instrumentation probe from said set of custom instrumentation probes; receiving a subset of operating system, network, and application events data corresponding to a system in connection with the set of custom instrumentation probes; generating a chain of responsibility process tree based on instrumenting the system at the operating system level and the collected data, wherein the chain of responsibility process tree traces a flow of data in the system; mapping corresponding operating system level process to a direct or indirect parent process that is assigned as an entry point for a logical application among a plurality of logical applications by implementing the chain of responsibility process tree; and assigning, in response to mapping, attribution data to the logical application.

According to exemplary embodiments, when it is determined that a new process is scheduled, the instructions, when executed, may cause the processor to further perform the following: retrieving a tag for a parent process from the chain of responsibility process tree; storing the tag indexed by the new process along with a tag identifier onto a memory; and utilizing the tag identifier by accessing the memory to identify a corresponding application and determining what the system is processing.

According to exemplary embodiments, the instructions, when executed, may cause the processor to detect behaviors or actions by monitoring the chain of responsibility process tree so that the behaviors or actions can be ascribed to a specific party responsible for the behaviors or actions thereby identifying on whose behalf the behaviors or actions were taken. Thus, according to exemplary embodiments, the instructions, when executed, may cause the processor to further perform the following: detecting an unauthorized behavior by monitoring the flow of data in the system; and attributing any file access, network communication, and/or system call to the logical application that is responsible for the unauthorized behavior.

According to exemplary embodiments, the instructions, when executed, may cause the processor to further perform the following: identifying applications among the logical applications that are using cryptography; automatically instrumenting the identified applications at the operating system level based on implementing the instrumentation probe from said set of custom instrumentation probes; and automatically monitoring activities of the identified applications.

According to exemplary embodiments, the instructions, when executed, may cause the processor to further perform the following: implementing configurable filtering to reduce amount of data collected that need to be sent for off system processing.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, cloud, and language agnostic attribution data assignment module for collecting attribution data and assigning the attribution data to an application for externally observed usage of cryptography in accordance with an exemplary embodiment.

FIG. 2 illustrates an exemplary diagram of a network environment with a platform, cloud, and language agnostic attribution data assignment device in accordance with an exemplary embodiment.

FIG. 3 illustrates a system diagram for implementing a platform, cloud, and language agnostic attribution data assignment device having a platform, cloud, and language agnostic attribution data assignment module in accordance with an exemplary embodiment.

FIG. 4 illustrates a system diagram for implementing a platform, cloud, and language agnostic attribution data assignment module of FIG. 3 in accordance with an exemplary embodiment.

FIG. 5 illustrates an exemplary process implemented by the platform, cloud, and language agnostic attribution data assignment module of FIG. 4 for attribution data collection and reduction in accordance with an exemplary embodiment.

FIG. 6 illustrates an exemplary system architecture of attribution implemented by the platform, cloud, and language agnostic attribution data assignment module of FIG. 4 in accordance with an exemplary embodiment.

FIG. 7 illustrates an exemplary process responsibility tree approach implemented by the platform, cloud, and language agnostic attribution data assignment module of FIG. 4 in accordance with an exemplary embodiment.

FIG. 8A illustrates another exemplary process responsibility tree approach implemented by the platform, cloud, and language agnostic attribution data assignment module of FIG. 4 in accordance with an exemplary embodiment describing the flow when a task terminates resulting in that task's entry in the responsibility tree being removed.

FIG. 8B illustrates another exemplary process responsibility tree approach implemented by the platform, cloud, and language agnostic attribution data assignment module of FIG. 4 in accordance with an exemplary embodiment illustrating that when an event of interest occurs, the responsibility data can be retrieved from a table and included with the event hence providing the responsibility linkage.

FIG. 9 illustrates an exemplary flow chart implemented by the platform, cloud, and language agnostic attribution data assignment module of FIG. 4 for collecting attribution data and assigning the attribution data to an application for externally observed usage of cryptography in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

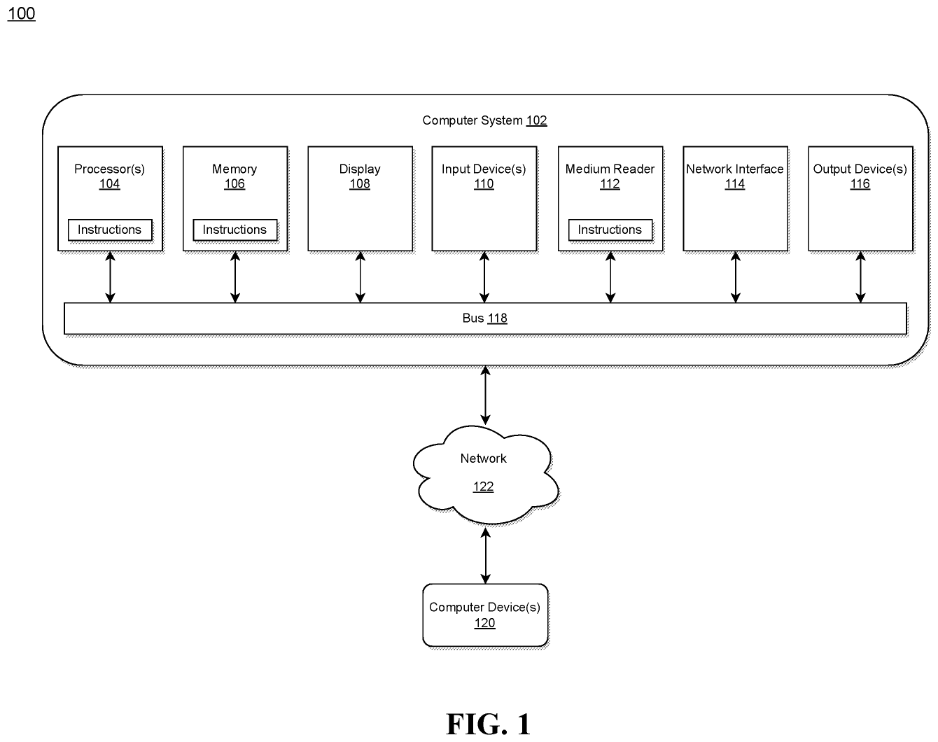

FIG. 1 is an exemplary system 100 for use in implementing a platform, cloud, and language agnostic attribution data assignment module that may be configured for collecting attribution data and assigning the attribution data to an application for externally observed usage of cryptography in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

According to exemplary embodiments, the attribution data assignment module may be platform, language, database, and cloud agnostic that may allow for consistent easy orchestration and passing of data through various components to output a desired result. Since the disclosed process, according to exemplary embodiments, is platform, language, database, and cloud agnostic, the attribution data assignment module may be independently tuned or modified for optimal performance without affecting the configuration or data files. The configuration or data files, according to exemplary embodiments, may be written using JSON, but the disclosure is not limited thereto. For example, the configuration or data files may easily be extended to other readable file formats such as XML, YAML, etc., or any other configuration-based languages. For example, the data files may easily be extended to other files formats such as CSV, RDF, OWL, etc., or any other structured, semi-structured, or unstructured format.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionalities as described herein, and a processor described herein may be used to support a virtual processing environment.

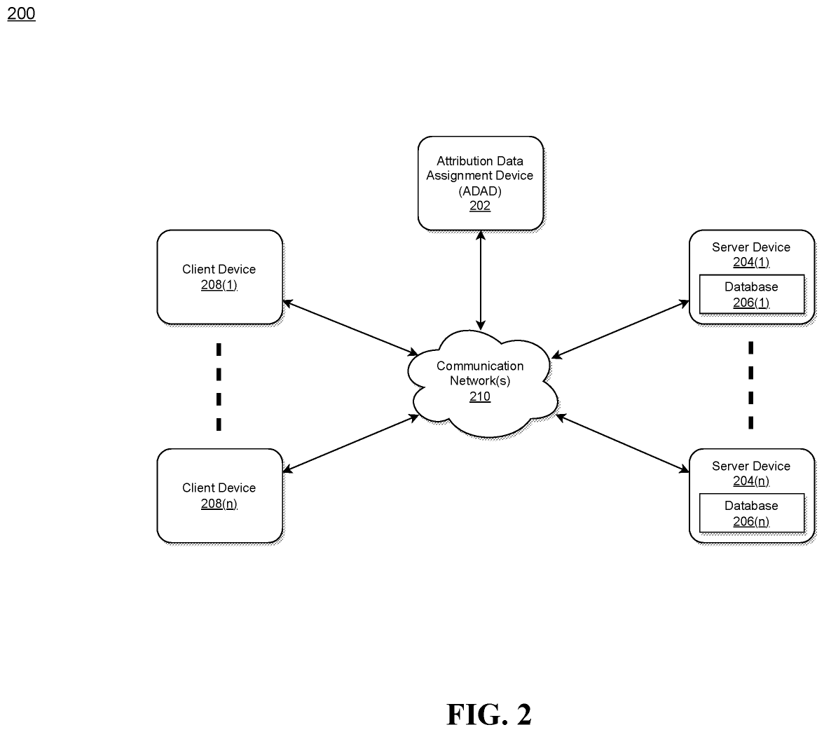

Referring to FIG. 2, a schematic of an exemplary network environment 200 for implementing a platform, cloud, and language agnostic attribution data assignment device (ADAD) of the instant disclosure is illustrated.

According to exemplary embodiments, the above-described problems associated with conventional tools may be overcome by implementing an ADAD 202 as illustrated in FIG. 2 that may be configured for applying multi-armed bandit algorithms for collecting attribution data and assigning the attribution data to an application for externally observed usage of cryptography, but the disclosure is not limited thereto. For example, according to exemplary embodiments, the above-described problems associated with conventional tools may be overcome by implementing an ADAD 202 as illustrated in FIG. 2 that may be configured to non-invasively instrument a system at an operating system (OS) level in order to capture a “chain of responsibility” process tree and utilize the “chain of responsibility” process tree to map any OS level process to a direct or indirect parent process that is assigned as the entry point for a logical application, thereby identifying the owner in a way that may be unique to each administration domain, but the disclosure is not limited thereto. Moreover, the ADAD may be configured to implement a attribution data assignment module, to: utilize this map to attribute any file access, network communication, or system call to a specific responsible logical application; follow the potential uses of cryptography by logical applications by following the flows of cryptographic data withing the system; identify applications that might be using cryptography and, if desired, automatically instrument them to understand exactly what they might be doing, but the disclosure is not limited thereto.

The ADAD 202 may be the same or similar to the computer system 102 as described with respect to FIG. 1.

The ADAD 202 may store one or more applications that can include executable instructions that, when executed by the ADAD 202, cause the ADAD 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ADAD 202 itself, may be located in virtual server(s) running in a cloud-based computing environment rather than being tied to one or more specific physical network computing devices. Also, the application(s) may be running in one or more virtual machines (VMs) executing on the ADAD 202. Additionally, in one or more embodiments of this technology, virtual machine(s) running on the ADAD 202 may be managed or supervised by a hypervisor.

In the network environment 200 of FIG. 2, the ADAD 202 is coupled to a plurality of server devices 204(1)-204(n) that hosts a plurality of databases 206(1)-206 (n), and also to a plurality of client devices 208(1)-208(n) via communication network(s) 210. A communication interface of the ADAD 202, such as the network interface 114 of the computer system 102 of FIG. 1, operatively couples and communicates between the ADAD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ADAD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 202 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ADAD 202 may be a standalone device or integrated with one or more other devices or apparatuses, such as one or more of the server devices 204(1)-204(n), for example. In one particular example, the ADAD 202 may be hosted by one of the server devices 204(1)-204(n), and other arrangements are also possible. Moreover, one or more of the devices of the ADAD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ADAD 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206 (n) that are configured to store metadata sets, data quality rules, and newly generated data, but the disclosure is not limited thereto. For example, the database(s) 206(1)-206 (n) may be a mainframe database, a log database that may produce programming for searching, monitoring, and analyzing machine-generated data via a web interface, etc., but the disclosure is not limited thereto. The database(s) 206(1)-206 (n) may also include relational databases and NoSQL databases (key-value, column, document, graph, multi-model, etc.). Moreover, the ADAD 202 may be configured to leverage any database protocol (i.e., Java Database Connectivity, Open Database Connectivity, etc.) and distributed file systems for reading/writing data (i.e., Hadoop Distributed File System, Amazon Simple Storage Service, etc.).

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the ADAD 202 that may efficiently provide a platform for implementing a platform, cloud, and language agnostic attribution data assignment module for collecting attribution data and assigning the attribution data to an application for externally observed usage of cryptography, but the disclosure is not limited thereto. For example, according to exemplary embodiments, the client devices 208(1)-208(n) in this example may include any type of computing device that can facilitate the implementation of the ADAD 202 that may efficiently provide a platform for implementing a platform, cloud, and language agnostic attribution data assignment module that that may be configured to non-invasively instrument a system at an operating system (OS) level in order to capture a “chain of responsibility” process tree and utilize the “chain of responsibility” process tree to map any OS level process to a direct or indirect parent process that is assigned as the entry point for a logical application, thereby identifying the owner in a way that may be unique to each administration domain, but the disclosure is not limited thereto. Moreover, the attribution data assignment module implemented with the client devices 208(1)-208(n), according to exemplary embodiments, may be configured to: utilize this map to attribute any file access, network communication, or system call to a specific responsible logical application; follow the potential uses of cryptography by logical applications by following the flows of cryptographic data withing the system; identify applications that might be using cryptography and, if desired, automatically instrument them to understand exactly what they might be doing, but the disclosure is not limited thereto.

The client devices 208(1)-208(n) may run interface applications, such as standard web browsers or standalone client applications, which may provide an interface to communicate with the ADAD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the ADAD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ADAD 202, the server devices 204(1)-204(n), or the client devices 208(1)-208(n), for example, may be configured to operate as virtual instances on the same physical machine. For example, one or more of the ADAD 202, the server devices 204(1)-204(n), or the client devices 208(1)-208(n) may operate on the same physical device rather than as separate devices communicating through communication network(s) 210. Additionally, there may be more or fewer ADADs 202, server devices 204(1)-204(n), or client devices 208(1)-208(n) than illustrated in FIG. 2. According to exemplary embodiments, the ADAD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

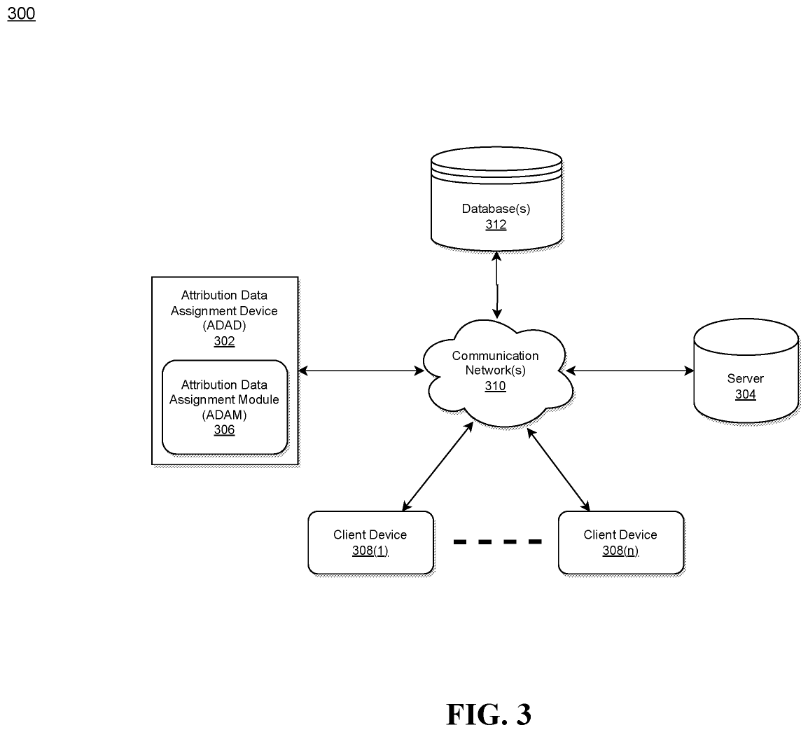

FIG. 3 illustrates a system diagram for implementing an ADAD having a platform, cloud, and language agnostic attribution data assignment module (ADAM) in accordance with an exemplary embodiment.

As illustrated in FIG. 3, the system 300 may include an ADAD 302 within which an ADAM 306 is embedded, a server 304, a database(s) 312, a plurality of client devices 308(1) . . . 308(n), and a communication network 310.

According to exemplary embodiments, the ADAD 302 including the ADAM 306 may be connected to the server 304, and the database(s) 312 via the communication network 310. The ADAD 302 may also be connected to the plurality of client devices 308(1) . . . 308(n) via the communication network 310, but the disclosure is not limited thereto.

According to exemplary embodiment, the ADAD 302 is described and shown in FIG. 3 as including the ADAM 306, although it may include other rules, policies, modules, databases, or applications, for example. According to exemplary embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. For example, the database(s) 312 may also include relational databases and NoSQL databases (key-value, column, document, graph, multi-model, etc.). Moreover, the ADAM 306 may be configured to leverage any database protocol (i.e., Java Database Connectivity, Open Database Connectivity, etc.) and distributed file systems for reading/writing data (i.e., Hadoop Distributed File System, Amazon Simple Storage Service, etc.).

According to exemplary embodiments, the ADAM 306 may be configured to receive real-time feed of data from the plurality of client devices 308(1) . . . 308(n), and the database(s) 312 via the communication network 310. According to exemplary embodiments, the ADAM 306 may be configured to utilize stream processing systems as the real-time feed. For example, the real-time feed(s) may be a stream processing system, such as Apache Kafka, Apache Spark, Amazon Kinesis, etc., but the disclosure is not limited thereto.

As will be described below, the ADAM 306 may be configured to: implement a set of custom instrumentation probes to collect data; instrument the system at an operating system level based on implementing an instrumentation probe from said set of custom instrumentation probes; receive a subset of operating system, network, and application events data corresponding to a system in connection with the set of custom instrumentation probes; generate a chain of responsibility process tree based on instrumenting the system at the operating system level and the collected data, wherein the chain of responsibility process tree traces a flow of data in the system; map corresponding operating system level process to a direct or indirect parent process that is assigned as an entry point for a logical application among a plurality of logical applications by implementing the chain of responsibility process tree; and assign, in response to mapping, attribution data to the logical application, but the disclosure is not limited thereto.

The plurality of client devices 308(1) . . . 308(n) are illustrated as being in communication with the ADAD 302. In this regard, the plurality of client devices 308(1) . . . 308(n) may be “clients” (e.g., customers) of the ADAD 302 and are described herein as such. Nevertheless, it is to be known and understood that the plurality of client devices 308(1) . . . 308(n) need not necessarily be “clients” of the ADAD 302, or any entity described in association therewith herein. Any additional or alternative relationship may exist between either or both of the plurality of client devices 308(1) . . . 308(n) and the ADAD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the ADAD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The ADAD 302 may be the same or similar to the ADAD 202 as described with respect to FIG. 2, including any features or combination of features described with respect thereto.

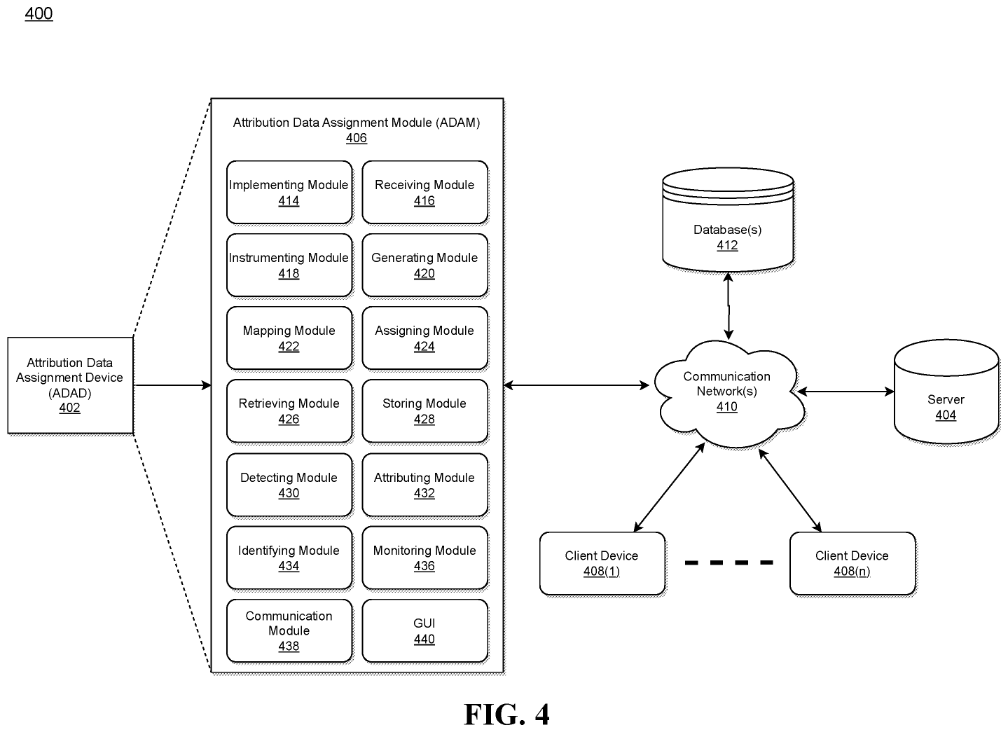

FIG. 4 illustrates a system diagram for implementing an ADAM of FIG. 3 in accordance with an exemplary embodiment.

According to exemplary embodiments, the system 400 may include a platform, cloud, and language agnostic ADAD 402 within which a platform, cloud, and language agnostic ADAM 406 is embedded, a server 404, database(s) 412, and a communication network 410.

According to exemplary embodiments, the ADAD 402 including the ADAM 406 may be connected to the server 404 and the database(s) 412 via the communication network 410. The ADAD 402 may also be connected to the plurality of client devices 408(1)-408 (n) via the communication network 410, but the disclosure is not limited thereto. The ADAM 406, the server 404, the plurality of client devices 408(1)-408 (n), the database(s) 412, the communication network 410 as illustrated in FIG. 4 may be the same or similar to the ADAM 306, the server 304, the plurality of client devices 308(1)-308(n), the database(s) 312, the communication network 310, respectively, as illustrated in FIG. 3.

According to exemplary embodiments, as illustrated in FIG. 4, the ADAM 406 may include an implementing module 414, a receiving module 416, an instrumenting module 418, a generating module 420, a mapping module 422, an assigning module 424, a retrieving module 426, a storing module 428, a detecting module 430, an attributing module 432, an identifying module 434, a monitoring module 436, a communication module 438, and a GUI 440. According to exemplary embodiments, interactions and data exchange among these modules included in the ADAM 406 provide the advantageous effects of the disclosed invention. Functionalities of each module of FIG. 4 may be described in detail below with reference to FIGS. 4-8.

According to exemplary embodiments, each of the implementing module 414, the receiving module 416, the instrumenting module 418, the generating module 420, the mapping module 422, the assigning module 424, the retrieving module 426, the storing module 428, the detecting module 430, the attributing module 432, the identifying module 434, the monitoring module 436, and the communication module 438 of the ADAM 406 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

According to exemplary embodiments, each of the implementing module 414, the receiving module 416, the instrumenting module 418, the generating module 420, the mapping module 422, the assigning module 424, the retrieving module 426, the storing module 428, the detecting module 430, the attributing module 432, the identifying module 434, the monitoring module 436, and the communication module 438 of the ADAM 406 may be implemented by microprocessors or similar, and may be programmed using software (e.g., microcode) to perform various functions discussed herein and may optionally be driven by firmware and/or software.

Alternatively, according to exemplary embodiments, each of the implementing module 414, the receiving module 416, the instrumenting module 418, the generating module 420, the mapping module 422, the assigning module 424, the retrieving module 426, the storing module 428, the detecting module 430, the attributing module 432, the identifying module 434, the monitoring module 436, and the communication module 438 of the ADAM 406 may be implemented by dedicated hardware, or as a combination of dedicated hardware to perform some functions and a processor (e.g., one or more programmed microprocessors and associated circuitry) to perform other functions.

According to exemplary embodiments, each of the implementing module 414, the receiving module 416, the instrumenting module 418, the generating module 420, the mapping module 422, the assigning module 424, the retrieving module 426, the storing module 428, the detecting module 430, the attributing module 432, the identifying module 434, the monitoring module 436, and the communication module 438 of the ADAM 406 may be called via corresponding API.

The process may be executed via the communication module 438 and the communication network 410, which may comprise plural networks as described above. For example, in an exemplary embodiment, the various components of the ADAM 406 may communicate with the server 404, and the database(s) 412 via the communication module 438 and the communication network 410. Of course, these embodiments are merely exemplary and are not limiting or exhaustive.

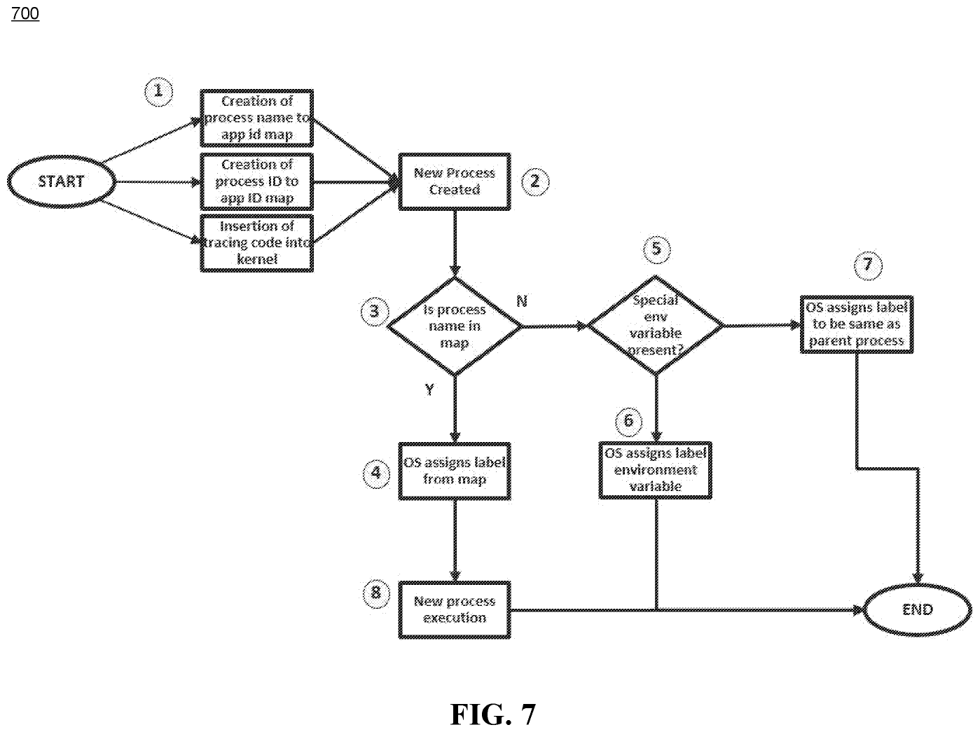

According to exemplary embodiments, the implementing module 414 may be configured to implement a set of custom instrumentation probes to collect data. The instrumenting module 418 may be configured to instrument the system at an operating system level based on implementing an instrumentation probe from the set of custom instrumentation probes. The receiving module 416 may be configured to receive a subset of operating system, network, and application events data corresponding to a system in connection with the set of custom instrumentation probes. The generating module 420 may be configured to generate a chain of responsibility process tree based on instrumenting the system at the operating system level and the collected data. The chain of responsibility process tree traces a flow of data in the system (see, e.g., FIG. 7). The mapping module 422 may be configured to map corresponding operating system level process to a direct or indirect parent process that is assigned as an entry point for a logical application among a plurality of logical applications by implementing the chain of responsibility process tree. The assigning module 424 may be configured to assign, in response to mapping, attribution data to the logical application.

For example, the ADAM 406 may be configured to non-invasively instrument a system at an operating system (OS) level in order to allow a first party to delegate responsibility to a next party and so on, thereby one can follow the chain of delegation back to the originator. That is, each process inherits its parent information so that if the parent predeceases the child, the parent's information is retained. Moreover, according to exemplary embodiments, the responsibility does not correspond to user accounts—as delegation can cross account boundaries.

According to exemplary embodiments, each of the logical applications has different and organizationally unrelated owners and implements dependent processes that carry out operation on behalf of a corresponding owner, but the disclosure is not limited thereto. For example, the designated owners (or administration domains) may be distinct from and have no relationship to any operating system definition of owners and security domains.

According to exemplary embodiments, the attribution data may correspond to data that identifies an owner of the logical application in a way this is unique to each administration domain or line of business, but the disclosure is not limited thereto.

According to exemplary embodiments, when it is determined that a new process is scheduled, the retrieving module 426 may be configured to retrieve a tag for a parent process from the chain of responsibility process tree. The storing module 428 may be configured to store the tag indexed by the new process along with a tag identifier onto a memory (i.e., memory 106 as illustrated in FIG. 1) and the ADAM 406 may be configured to utilize the tag identifier by accessing the memory to identify a corresponding application and determining what the system is processing. According to exemplary embodiments, the term “tag” could be more than just a tag. For example, the tap might be a whole collection of data items without departing from the scope of the present disclosure.

According to exemplary embodiments, the ADAM 406 may be configured to detect behaviors or actions by monitoring the chain of responsibility process tree so that the behaviors or actions can be ascribed to a specific party responsible for the behaviors or actions thereby identifying on whose behalf the behaviors or actions were taken. Thus, according to exemplary embodiments, the detecting module 430 may be configured to detect an unauthorized behavior by monitoring the flow of data in the system; and the attributing module 432 may be configured to attribute any file access, network communication, and/or system call to the logical application that is responsible for the unauthorized behavior.

According to exemplary embodiments, the identifying module 434 may be configured to identify applications among the logical applications that are using cryptography. The instrumenting module 418 may be configured to automatically instrument the identified applications at the operating system level based on implementing the instrumentation probe from the set of custom instrumentation probes and the monitoring module 436 may be configured to automatically monitor activities of the identified applications by utilizing the GUI 440.

According to exemplary embodiments, the implementing module 414 may be further configured to implement configurable filtering to reduce amount of data collected that need to be sent for off system processing.

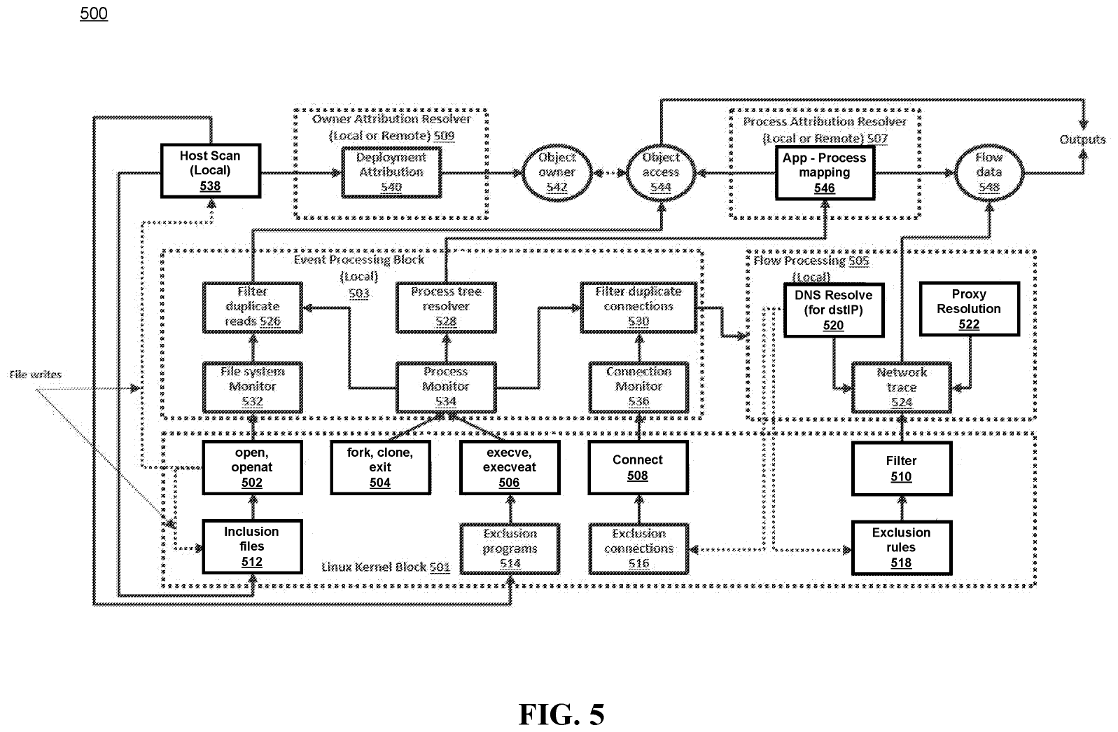

As illustrated in FIGS. 5-8, any reference to a “block” may also be interchangeably referred to as “module.”

FIG. 5 illustrates an exemplary process 500 implemented by the platform, cloud, and language agnostic ADAM 406 of FIG. 4 for attribution data collection and reduction in accordance with an exemplary embodiment. As illustrated in FIG. 5, the process 500 may include a Linux kernel block 501 that may include an open, openat 502 to open or create a file for reading, writing or executing (i.e., inclusion files 512); a fort, clone, and exit block 504. The ADAM 406 may create a process using fork ( ) system call. The fork ( ) is a special system call utilized by the ADAM 406 to call it once, but the function returns twice: Once in the parent, and once in the child process. Thus, fork ( ) increases the number of processes in the system by one. The system call exit ( ) decrements the number of system calls. The system call clone ( ) creates a child process. The exit ( ) is a system call that is entered once and never leave. The exit ( ) call decrements the number of processes in the system by one. The exit ( ) also accepts an exit status as a parameter, which the parent process can receive (or even has to receive), and which communicates the fate of the child to the parent. In the example illustrated in FIG. 7, all variants of the program call exit ( )—the ADAM 406 is calling exit ( ) in the child process, but also in the parent process. Thus, the exit ( ) terminates two processes.

As illustrated in FIG. 5, the Linux kernel block 501 also includes an execve, execveat block 506 that receives, as input, exclusion programs 514. The execveat ( ) system call executes the program referred to by the combination of dirfd and pathname. The Linux kernel block 501 also includes a connect block 508 that receives, as input, exclusion connections 516. The Linux kernel block 501 also includes a filter 510 (i.e., NetFilter) that receives exclusion rules 518 and reduce data.

As illustrated in FIG. 5, the process 500 may also include an event processing block 503 that includes filter duplicate reads 526 that receives data from the file system monitor 532 and the process monitor 534, process tree resolver 528 that receives data from the process monitor 534, filter duplicate connections 530 that receives data from the process monitor 534 and the connection monitor 536. The process monitor 534 receives data from the fork, clone, exit block 504 and execve, execveat block 506. The file system monitor 532 receives data from the open, openat block 502. The connection monitor 536 receives data from the connect block 508. Output from the filer duplicate connections 530 is input to a flow processing 505 as disclosed below.

As illustrated in FIG. 5, the process 500 may also include a flow processing 505 block that may include a network trace block 524 that receives data from the filter 510, DNS resolve (for dstIP) and proxy resolution 522.

As illustrated in FIG. 5, the process 500 may also include a process attribution resolver (local or remote) 507 that may include an application process mapping block 546 that receives data, as input, from the process tree resolver 528, outputs data to object access block 544 and flow data block 548. The object access block 544 also receives data from filter duplicate reads block 526 and outputs to object owner 542. According to exemplary embodiments, the object access block 544 may be bi-directionally communicate with the object owner to receive data from the object owner 542 as well as to output data to the object owner 542. The flow data block 548 receives data, as input, from the application process mapping block 546 and the network trace block 524 to output data.

As illustrated in FIG. 5, the process 500 may also include an owner attribution resolver (local or remote) 509 that includes a deployment attribution block 540 that receives data from a host scan (local) 538. The host scan (local) block 538 may receive data from open, openat block 502 and outputs data to the exclusion programs 514 and inclusion files 512. The deployment attribution block 540 assigns attribute data received based on scanning to the object owner 542.

Additional exemplary details with reference to FIG. 5 will be described below.

For example, the system that implements the process 500 of FIG. 5 may include a set of tracing modules (1) that may be safely injected into the operating system (OS) to watch for file accesses, process creation and termination, and network communications, and access to system keyrings should they be present.

According to exemplary embodiments, the process monitor 534 constructs the process tree of creation for each process to ensure that the parentage is correct as there are programming idioms that may likely change that parentage quickly thereby destroying one's ability to reconstruct the chain of responsibility for a process' existence. According to exemplary embodiments, a file tracer notices which processes (identified at the OS level) access these files for reading and it looks for all cases of file writes. A network connection tracer (i.e., network trace block 524) that captures which processes (seen at the OS level) initial network session with other systems.

According to exemplary embodiments, a module (2) (i.e., filter 510) that performs packet captures, i.e., capturing the first few packets of every session. When matched with the output of the network trace block 524, the ADAM 406 may reconstruct which process made use of specific cryptography. This module (2) may also detect the use of explicit proxies (3) (i.e., output from the proxy resolution block 522) and with that information associate individual process with the intended destinations for network communications. A module (i.e., DNS resolve block 520) that captures DNS name service requests (4) and records the (possibly many) IP addresses that the names resolved to.

According to exemplary embodiments, a host scanner (7) (i.e., host scan block 538) that may be configured to (a) identify any file that contains cryptographic material (keys and certificates), and (b) identify libraries that are known to contain encryption algorithms. The host scanner (7) works over the filesystem and created the list of (inclusion files 512-(5)) that may be used initially by the host scanner that traces file accesses. Where possible attributes them to an owner, i.e., object owner 542, (which might be different for the consumer) by looking at where the data is in the file system or what packages installed it.

Also, according to exemplary embodiments, the host scanner (7) may take note of libraries that are known to support cryptographic operations and applications that are known to be capable of generating cryptographic keys. The first are included in the file read watch list and the latter in a list of applications that might create files containing cryptographic material. In either case, files that are written may be passed to the host scanner (7) and might be included in the list of files to watch if they do contain relevant material.

According to exemplary embodiments, the process 500 implemented by the ADAM 406 may also include an event processing module (i.e., event processing block (local) 503) that collates the results from the traces and uses a “process responsibility tree” (6) (output from the process tree resolver 528) to connect detected actions with both OS level processes and the logical application that the observed set of processes comprise. This logical application designator may then be attached to the outputs of the system which may comprise a list of files and their observed accessors and network connections and the responsible originators. The modules illustrated in the event processing block 503 (i.e., 526, 528, 530, 532, 534, 536) may be implemented as a single application or a cooperating set of applications.

According to exemplary embodiments, each tracing component may be presumed to be configurable to the extent that it can be toggled on or off as well as being able to incorporate list of events of special interest or lists to ignore. This is important because of the large amount of data that can be collected and that one may turn parts of this system off or may at the source filter out know accesses and flows. For example, if it is known that specific applications are always talking to a specific system, the system can choose to ignore those communications (at the filter level). Also automated decision algorithms running in the event processing module may use these hooks to reconfigure the tracers to look for more events or to silence known events.

According to exemplary embodiments, the process 500 implemented by the ADAM 406 may also include an exclusion module (8) for excluding some undesirable programs (i.e., programs that are known not to be of interest and unable to contribute to the final answers) prior to sending data to the “execve, execveat” block 506, for excluding some undesired connections prior to sending data to the connect block 508, and for excluding some undesired rules prior to sending data to the filter 510.

According to exemplary embodiments, some of the processing designated as ‘local’ above could be done in either kernel or user space. For example, filtering duplicate network connections could be handled in the kernel using a BPF (Berkeley Packet Filter) map that matches on (process id, remote address, remote port). According to exemplary embodiments, only reporting the “unique’ connections can then be used (in user space) to extract the entries of interest from the network traces obtained from the filter 510.

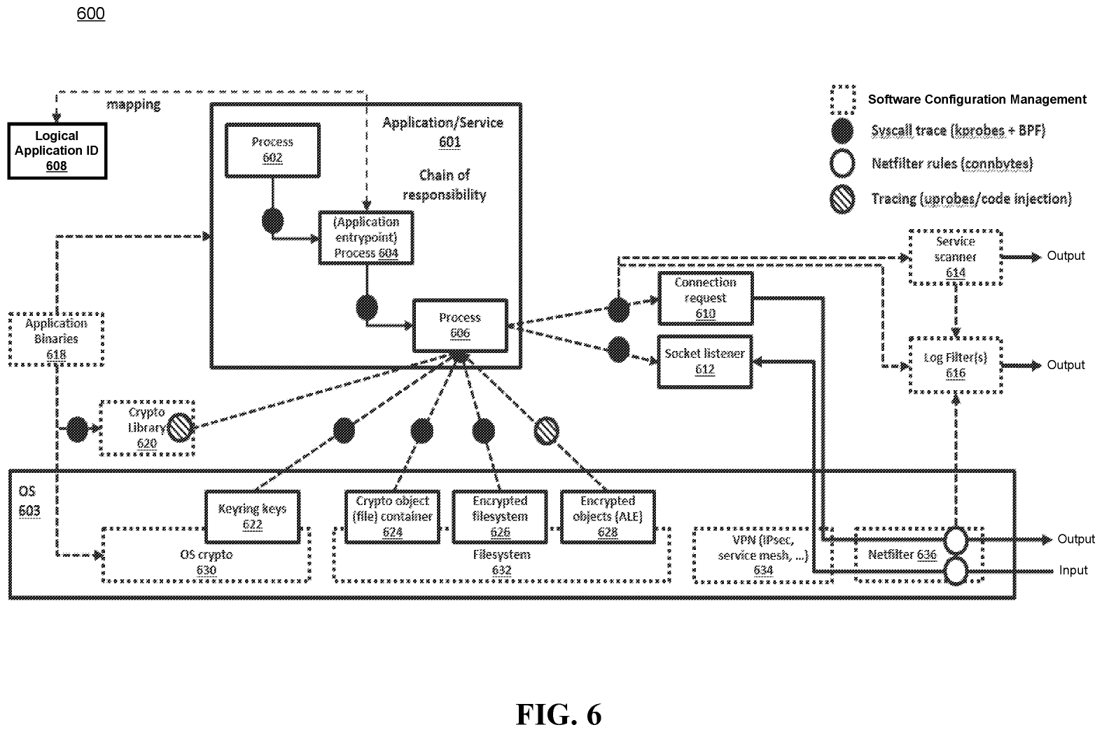

FIG. 6 illustrates an exemplary system architecture 600 of attribution implemented by the platform, cloud, and language agnostic ADAM 406 of FIG. 4 in accordance with an exemplary embodiment. The exemplary system architecture 600 illustrates the “process responsibility tree” (6) (output from the process tree resolver 528) and how a particular interior node of this tree would be mapped to the logical application. All processes, and their actions, below the mapped node would be considered the responsibility of the owning application.

According to exemplary embodiments, a logical application ID 608) is the internal name for how the ADAM 406 designates logical applications. It is possible for one logical application to invoke another. In that case, the attribution might be to logical application (owner) closest to the event of interest. Although for some contexts, it may be possible to point out both owners as responsible parties, and their relationship in this system context as desired or necessary.

According to exemplary embodiments, there may be a possibility to identify the original owner of a library as originating a file access or network connection as that could provide an enhanced view of attribution when the library called by a process does something that the caller was not aware of.

According to exemplary embodiments, a “Service Scanner” is an otherwise unrelated external tool that can be driven by the output of system illustrated in FIG. 6.

For example, as illustrated in FIG. 6, the exemplary system architecture 600 of attribution implemented by the platform, cloud, and language agnostic ADAM 406 of FIG. 4 may include an application/service 601 and an OS 603. The application/service 601 may include a parent process 602 operatively connected to an application entry point process 604 that is operatively connected to a child process 606 to illustrate a chain of responsibility. The application entry point process 604 utilizes the logical application ID 608.

According to exemplary embodiments, the OS 603 may include an OS crypto 630 that may include keyring keys 622; a filesystem 632 that may include crypto object (file) container 624, encrypted filesystem 626, and encrypted objects (Application Level Encryption (ALE), in which a specialized encryption is done within applications for protecting data at rest rather than in transit) 628; a VPN (IPsec (internet protocol security), service mesh, etc.) 634; and a Netfilter 636. The application/service 601 may be bi-directionally operatively connected to receive/send data from the OS crypto 630 via application binaries 618 by calling corresponding system call trace (kprobes (that enables to dynamically break into any kernel routine and collect debugging and performance information non-disruptively)+BPF syntax). The child process 606 may be operatively connected to receive data from a crypto library 620 by either uprobes or explicit code injection into applications. The child process 606 may be operatively connected to receive data from the keyring keys 622, the crypto object (file) container 624, and the encrypted filesystem 626 by calling corresponding system call trace (kprobes+BPF). The child process 606 may be operatively connected to receive data from the encrypted objects (ALE) 628 by tracing (uprobes/code injection). Output from the child process 606 may be input to connection request block 610 and socket listener 612. A uprobe is a way of having the kernel insert a breakpoint into an executable file at a specific offset.

According to exemplary embodiments, the socket listener 612 receives data as input by utilizing VPN 634 and Netfilter 636. The connection request 610 outputs data by utilizing VPN 634 and Netfilter 636.

As illustrated in FIG. 6, both the service scanner 614 and the log filter(s) 616 output data as received from the child process 606 by calling corresponding system call trace (kprobes+BPF).

According to exemplary embodiments, the following system initialization steps may be implemented by the ADAM 406: (i) set up two BPF maps early in the boot sequence (i.e., Command line to App ID—only need to be unique to first number of characters for index into map; Thread ID to App ID—may allow a Thread ID to immediately retrieve the associated App ID; (ii) environment configuration might be needed for the case where the command line would be too ambiguous (i.e., approach might be easy to use in general and might adapt to containers more easily (container started with the App ID)); (iii) tracing starts next in system startup sequence (i.e., file system probes and tracing can start right after filesystems are mounted; NetFilter tracing right after network and firewalls are up but before any DNS caching server if one is present); (iv) host scanner may be run periodically or on demand (i.e., need to filter its file accesses as it can go everywhere; any new files it finds are added to the “watch” list (e.g., some applications download and install new certificates)).

FIG. 7 illustrates an exemplary process responsibility tree approach 700 implemented by the platform, cloud, and language agnostic ADAM 406 of FIG. 4 in accordance with an exemplary embodiment. The exemplary process responsibility tree approach 700 illustrates how the responsibility tree can be managed in kernel space (using eBPF in Linux).

According to exemplary embodiments, in the exemplary process responsibility tree approach 700, the ADAM 406 implements the following processes:

At step (1), the mapping of process name to application ID is provisioned (preferably early in the boot sequence) and an (empty) mapping of process ID to application ID is created. For OS processes, the absence of an entry in the process to application ID map is regarded as indicative of the process being owned by the OS (i.e., the OS has the application ID ‘0’ by default). At the same time the tracing code is attached to the relevant events in the kernel. At step (2), a new process is created. At step (3) the process name is being looked up in a mapping of process names to application IDs by determining whether the process name exists on the map. At step (4), when the lookup returns a value (i.e., ‘1’ as ‘Yes’), it is assigned to the new process and its entry is inserted into the map, i.e., the OS assigns label from map. At step (5), when the lookup returns nothing (i.e., ‘0’ as ‘No’), the ADAM 406 checks to see if there is a “special” variable in the environment which holds the application ID. At step (6), when such an environment variable exists, then the process is assigned its value, i.e., the OS assigns label environment variable. At step (7), when no value is found, the new process is assigned the parent's application ID (the parent is still alive at this point), i.e., the OS assigns label to be the same as the parent process. At step (8), the value assigned to the process is entered into the table as a mapping between the (new) process' kernel ID and the application ID.

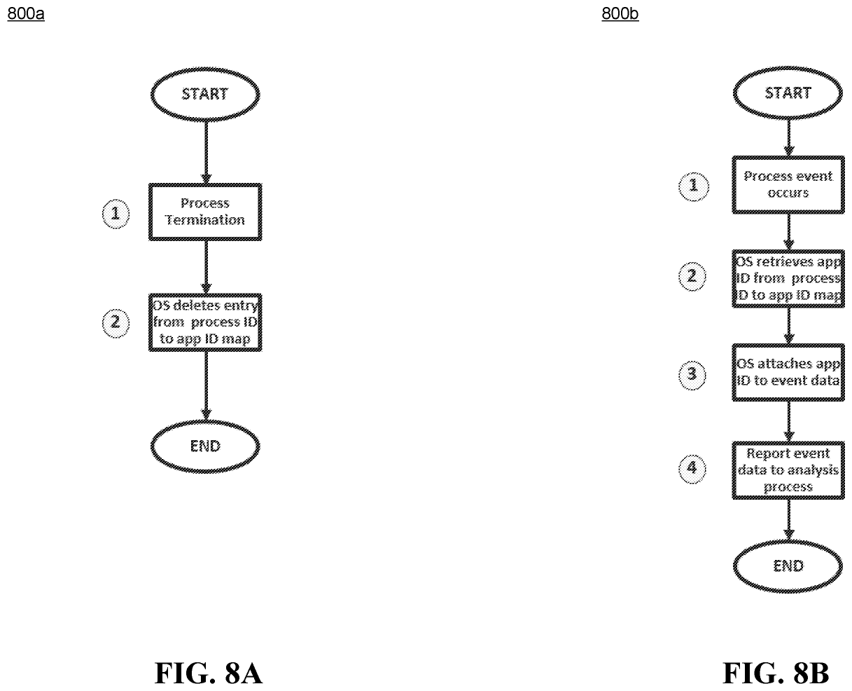

According to exemplary embodiments, when a process terminates, the termination event is captured and its kernel ID->application Id entry is removed from the mapping table (see, e.g., FIG. 8A below).

According to exemplary embodiments, steps (4) and (5) above are not necessary to the approach 700; rather, they are a useful technique.

When an event occurs, the event handling code looks up the process ID associated with the event and then used that to look up the application ID in the mapping (see, e.g., FIG. 8B below). Both of these values are reported to user space in the kernel event.

According to exemplary embodiments, the approach 700 as illustrated in FIG. 7 may be an in-kernel implementation, When the events are reported to a user space process, the ADAM 406 may be configured to implement the same algorithm, (excluding steps (4) and (5)) and monitor potential out of order deliver of events. Hence when removing an items from the mapping the ADAM 406 implements a “delay” just long enough to ensure that no events will be delivered that refer to the now defunct process.

FIG. 8A illustrates another exemplary process responsibility tree approach 800a implemented by the platform, cloud, and language agnostic ADAM 406 of FIG. 4 in accordance with an exemplary embodiment describing the flow when a task terminates resulting in that task's entry in the responsibility tree being removed. This exemplary process responsibility tree approach 800a corresponds to what happens when a process terminates and so its entry is removed from the responsibility table as it is now dead—and won't be responsible for anything. For example, as discussed above, according to exemplary embodiments, when a process terminates, the termination event is captured and its kernel ID->application Id entry is removed from the mapping table.

According to exemplary embodiments, in the exemplary process responsibility tree approach 800a, the ADAM 406 implements the following processes. At step (1), a process terminates. At step (2), the termination handler deletes the process ID from the mapping of process ID to application ID.

FIG. 8B illustrates another exemplary process responsibility tree approach 800b implemented by the platform, cloud, and language agnostic ADAM 406 of FIG. 4 in accordance with an exemplary embodiment illustrating that when an event of interest occurs, the responsibility data can be retrieved from a table and included with the event hence providing the responsibility linkage. For example, as discussed above, when an event occurs, the event handling code looks up the process ID associated with the event and then used that to look up the application ID in the mapping (see, e.g., FIG. 8B below). Both of these values are reported to user space in the kernel event.

According to exemplary embodiments, in the exemplary process responsibility tree approach 800b, the ADAM 406 implements the following processes. At step (1), a process event occurs (e.g., opening a file). At step (2), the application ID is retrieved from the mapping of process ID to application ID. At step (3) the retrieved application ID is attached to the event data. At step (4), the event is reported to the analysis processes.

According to exemplary embodiments, the ADAM 406 may be configured to tag processes with additional metadata that can be configured ahead of time in a table. For example, the metadata has no meaning in the kernel but has a persistent meaning outside, i.e., unlike the process IDs which is only meaningful for the duration of the process' lifetime. The ADAM 406 may also be configured to provision the mapping in a distributed way via environment variables.

According to exemplary embodiments, when an event happens, that metadata is attached to the event. This provides a persistent attribution to the event and a pointer to other (non-kernel) data about that application. For example, the ADAM 406 may be configured to store the command line as well in the map—or even a reference to the parent process name so a full tree can be built.

According to exemplary embodiments, the ADAM 406 may be configured to: discover potentially unexpected behavior of interest by tracing the “flow” of cryptographic data in the system and capturing writes to adaptively change the list of monitored files (e.g., moving or copying a certificate to a new location); detect access to cryptographic libraries that may be used to guide application tracing by utilizing a decision module (within an event processor) to decide what actions to take; detect specific communications patterns that may also be used to guide which applications should be invasively traced, e.g., connecting to a known key management service is suggestive of actions that may not be visible in OS events; implement Network filters that may be configured to suppress repeated events that are regarded as well known.

According to exemplary embodiments, the command line to application ID generated by the ADAM 406 may only be unique to first number of characters for index into map. The thread ID to application ID may allow a thread ID to immediately retrieve the associated application ID.

According to exemplary embodiments, the ADAM 406 may configure the environment for the case where the command line would be too ambiguous. This approach might adapt to containers more easily (container started with the application ID).

According to exemplary embodiments, the ADAM 406 may implement the following process tagging: (i) in fork/clone when new process is scheduled: retrieve the tag for the parent process and store that tag indexed by the (new) thread's TID; if there is no ID found this belongs to the system and do nothing; (ii) in exec: check the BPF map of command lines to application IDs, and if found, use this ID; check if there is a magic environment variable with an application ID: if found—use this ID and enter the TID/ID mapping into the process map (otherwise, process inherits parent's tag (which was already provisioned in the fork/clone step); (iii) in exit: delete the PID entry from the process map thereby ensuring that the PID will not be reused. Process tagging implemented by the ADAM 406 ensures that there is no need to collect and analyze a stream of events related to forks and clones-all processing is in kernel; and that attribution can be reliably assigned at the point the event is generated with no post processing necessary. According to exemplary embodiments, the ADAM 406 may be configured to use dynamically assigned labels at runtime.

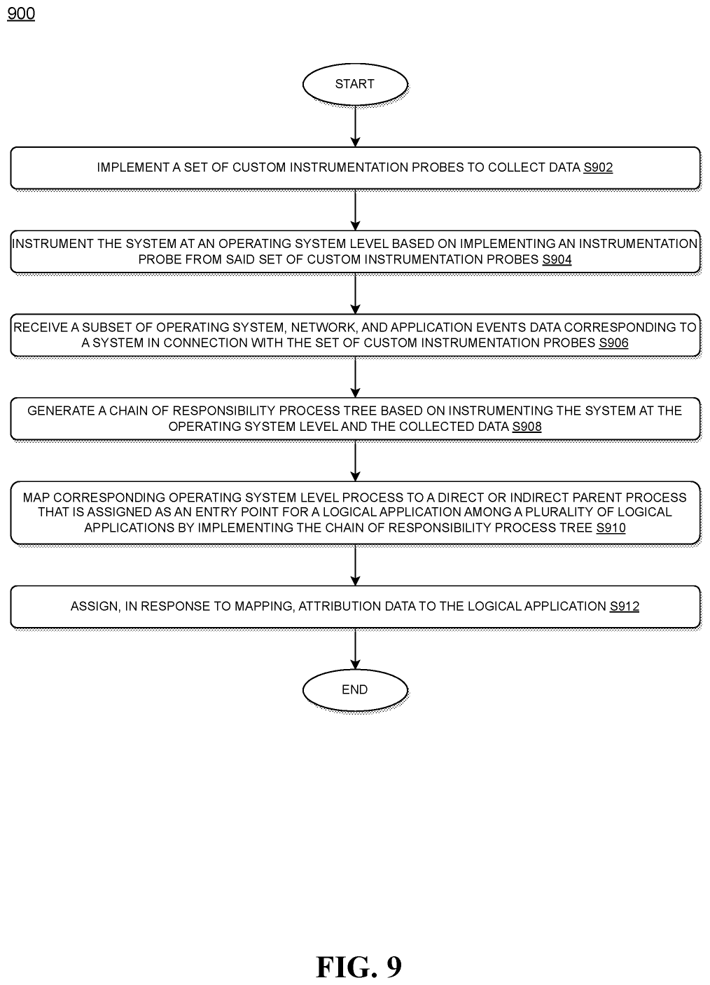

FIG. 9 illustrates an exemplary flow chart 900 implemented by the ADAM 409 of FIG. 4 for collecting attribution data and assigning the attribution data to an application for externally observed usage of cryptography in accordance with an exemplary embodiment. It will be appreciated that the illustrated process 900 and associated steps may be performed in a different order, with illustrated steps omitted, with additional steps added, or with a combination of reordered, combined, omitted, or additional steps.

As illustrated in FIG. 9, at step S902, the process 900 may include implementing a set of custom instrumentation probes to collect data.

At step S904, the process 900 may include instrumenting the system at an operating system level based on implementing an instrumentation probe from a set of custom instrumentation probes.

At step S906, the process 900 may include receiving a subset of operating system, network, and application events data corresponding to a system in connection with the set of custom instrumentation probes.

At step S908, the process 900 may include generating a chain of responsibility process tree based on instrumenting the system at the operating system level and the collected data, wherein the chain of responsibility process tree traces a flow of data in the system.

At step S910, the process 900 may include mapping corresponding operating system level process to a direct or indirect parent process that is assigned as an entry point for a logical application among a plurality of logical applications by implementing the chain of responsibility process tree.

At step S912, the process 900 may include assigning, in response to mapping, attribution data to the logical application.

According to exemplary embodiments, in the process 900, each of the logical applications has different and organizationally unrelated owners and implements dependent processes that carry out operation on behalf of a corresponding owner.

According to exemplary embodiments, in the process 900, the attribution data may correspond to data that identifies an owner of the logical application in a way this is unique to each administration domain or line of business, but the disclosure is not limited thereto.

According to exemplary embodiments, when it is determined that a new process is scheduled, the process 900 may further include: retrieving a tag for a parent process from the chain of responsibility process tree; storing the tag indexed by the new process along with a tag identifier onto a memory; and utilizing the tag identifier by accessing the memory to identify a corresponding application and determining what the system is processing.

According to exemplary embodiments, the instructions, the process 900 may further include: detecting behaviors or actions by monitoring the chain of responsibility process tree so that the behaviors or actions can be ascribed to a specific party responsible for the behaviors or actions thereby identifying on whose behalf the behaviors or actions were taken. Thus, according to exemplary embodiments, the process 900 may further include: detecting an unauthorized behavior by monitoring the flow of data in the system; and attributing any file access, network communication, and/or system call to the logical application that is responsible for the unauthorized behavior.

According to exemplary embodiments, the process 900 may further include: identifying applications among the logical applications that are using cryptography; automatically instrumenting the identified applications at the operating system level based on implementing the instrumentation probe from said set of custom instrumentation probes; and automatically monitoring activities of the identified applications.

According to exemplary embodiments, the process 900 may further include: implementing configurable filtering to reduce amount of data collected that need to be sent for off system processing.

According to exemplary embodiments, the ADAD 402 may include a memory (e.g., a memory 106 as illustrated in FIG. 1) which may be a non-transitory computer readable medium that may be configured to store instructions for implementing an ADAM 406 for assigning attribution data to an application as disclosed herein. The ADAD 402 may also include a medium reader (e.g., a medium reader 112 as illustrated in FIG. 1) which may be configured to read any one or more sets of instructions, e.g., software, from any of the memories described herein. The instructions, when executed by a processor embedded within the ADAM 406 or within the ADAD 402, may be used to perform one or more of the methods and processes as described herein. In a particular embodiment, the instructions may reside completely, or at least partially, within the memory 106, the medium reader 112, and/or the processor 104 (see FIG. 1) during execution by the ADAD 402.

According to exemplary embodiments, the instructions, when executed, may cause a processor embedded within the ADAM 406 or the ADAD 402 to perform the following: implementing a set of custom instrumentation probes to collect data; instrumenting the system at an operating system level based on implementing an instrumentation probe from said set of custom instrumentation probes; receiving a subset of operating system, network, and application events data corresponding to a system in connection with the set of custom instrumentation probes; generating a chain of responsibility process tree based on instrumenting the system at the operating system level and the collected data, wherein the chain of responsibility process tree traces a flow of data in the system; mapping corresponding operating system level process to a direct or indirect parent process that is assigned as an entry point for a logical application among a plurality of logical applications by implementing the chain of responsibility process tree; and assigning, in response to mapping, attribution data to the logical application, but the disclosure is not limited thereto. According to exemplary embodiments, the processor may be the same or similar to the processor 104 as illustrated in FIG. 1 or the processor embedded within ADAD 202, ADAD 302, ADAD 402, and ADAM 406.

According to exemplary embodiments, when it is determined that a new process is scheduled, the instructions, when executed, may further cause the processor 104 to perform the following: retrieving a tag for a parent process from the chain of responsibility process tree; storing the tag indexed by the new process along with a tag identifier; and utilizing the tag identifier to identify a corresponding application and determining what the system is processing.

According to exemplary embodiments, the instructions, when executed, may cause the processor 104 to detect behaviors or actions by monitoring the chain of responsibility process tree so that the behaviors or actions can be ascribed to a specific party responsible for the behaviors or actions thereby identifying on whose behalf the behaviors or actions were taken. Thus, according to exemplary embodiments, the instructions, when executed, may further cause the processor 104 to perform the following: detecting an unauthorized behavior by monitoring the flow of data in the system; and attributing any file access, network communication, and/or system call to the logical application that is responsible for the unauthorized behavior.

According to exemplary embodiments, the instructions, when executed, may further cause the processor 104 to perform the following: identifying applications among the logical applications that are using cryptography; automatically instrumenting the identified applications at the operating system level based on implementing the instrumentation probe from said set of custom instrumentation probes; and automatically monitoring activities of the identified applications.

According to exemplary embodiments, the instructions, when executed, may further cause the processor 104 to perform the following: implementing configurable filtering to reduce amount of data collected that need to be sent for off system processing.

According to exemplary embodiments as disclosed above in FIGS. 1-9, technical improvements effected by the instant disclosure may include a platform for implementing a platform, cloud, and language agnostic attribution data assignment module for collecting attribution data and assigning the attribution data to an application for externally observed usage of cryptography, but the disclosure is not limited thereto.

For example, according to exemplary embodiments as disclosed above in FIGS. 1-9, technical improvements effected by the instant disclosure may include a platform for implementing a platform, cloud, and language agnostic attribution data assignment module that may be configured to non-invasively instrument a system at an operating system (OS) level in order to capture a “chain of responsibility” process tree and utilize the “chain of responsibility” process tree to map any OS level process to a direct or indirect parent process that is assigned as the entry point for a logical application, thereby identifying the owner in a way that may be unique to each administration domain, but the disclosure is not limited thereto.

Moreover, according to exemplary embodiments as disclosed above in FIGS. 1-9, technical improvements effected by the instant disclosure may include a platform for implementing a platform, cloud, and language agnostic attribution data assignment module that may be configured to: utilize this map to attribute any file access, network communication, or system call to a specific responsible logical application; follow the potential uses of cryptography by logical applications by following the flows of cryptographic data withing the system; identify applications that might be using cryptography and, if desired, automatically instrument them to understand exactly what they might be doing, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for assigning attribution data to an application by utilizing one or more processors along with allocated memory, the method comprising:
implementing a set of custom instrumentation probes to collect data;
instrumenting the system at an operating system level based on implementing an instrumentation probe from said set of custom instrumentation probes;
receiving a subset of operating system, network, and application events data corresponding to a system in connection with the set of custom instrumentation probes;
generating a chain of responsibility process tree based on instrumenting the system at the operating system level and the collected data;
mapping corresponding operating system level process to a direct or indirect parent process that is assigned as an entry point for a logical application among a plurality of logical applications by implementing the chain of responsibility process tree; and
assigning, in response to mapping, attribution data to the logical application.

2. The method according to claim 1, wherein each of said logical applications has different and organizationally unrelated owners and implements dependent processes that carry out operation on behalf of a corresponding owner.

3. The method according to claim 2, wherein the attribution data corresponds to data that identifies an owner of the logical application in a way this is unique to each administration domain.

4. The method according to claim 1, when it is determined that a new process is scheduled, the method further comprising:
retrieving a tag for a parent process from the chain of responsibility process tree;
storing the tag indexed by the new process along with a tag identifier onto a memory; and
utilizing the tag identifier by accessing the memory to identify a corresponding application and determining what the system is processing.

5. The method according to claim 1, further comprising:
detecting a behavior by monitoring the chain of responsibility process tree so that the behavior can be ascribed to a specific party responsible for the behavior; and
attributing any file access, network communication, and/or system call to the logical application that is responsible for the behavior.

6. The method according to claim 1, further comprising:
identifying applications among the logical applications that are using cryptography;
automatically instrumenting the identified applications at the operating system level based on implementing the instrumentation probe from said set of custom instrumentation probes; and
automatically monitoring activities of the identified applications.

7. The method according to claim 1, further comprising:
implementing configurable filtering to reduce amount of data collected that need to be sent for off system processing.

8. A system for assigning attribution data to an application, the system comprising:
a processor; and
a memory operatively connected to the processor via a communication interface, the memory storing computer readable instructions, when executed, causes the processor to:
implement a set of custom instrumentation probes to collect data;
instrument the system at an operating system level based on implementing an instrumentation probe from said set of custom instrumentation probes;
receive a subset of operating system, network, and application events data corresponding to a system in connection with the set of custom instrumentation probes;
generate a chain of responsibility process tree based on instrumenting the system at the operating system level and the collected data;
map corresponding operating system level process to a direct or indirect parent process that is assigned as an entry point for a logical application among a plurality of logical applications by implementing the chain of responsibility process tree; and
assign, in response to mapping, attribution data to the logical application.

9. The system according to claim 8, wherein each of said logical applications has different and organizationally unrelated owners and implements dependent processes that carry out operation on behalf of a corresponding owner.

10. The system according to claim 9, wherein the attribution data corresponds to data that identifies an owner of the logical application in a way this is unique to each administration domain.

11. The system according to claim 8, when it is determined that a new process is scheduled, the processor is further configured to:
retrieve a tag for a parent process from the chain of responsibility process tree;
store the tag indexed by the new process along with a tag identifier onto a memory; and
utilize the tag identifier by accessing the memory to identify a corresponding application and determining what the system is processing.

12. The system according to claim 8, wherein the processor is further configured to:
detect a behavior by monitoring the chain of responsibility process tree so that the behavior can be ascribed to a specific party responsible for the behavior; and
attribute any file access, network communication, and/or system call to the logical application that is responsible for the behavior.

13. The system according to claim 8, wherein the processor is further configured to:
identify applications among the logical applications that are using cryptography;
automatically instrument the identified applications at the operating system level based on implementing the instrumentation probe from said set of custom instrumentation probes; and
automatically monitor activities of the identified applications.

14. The system according to claim 8, wherein the processor is further configured to:
implement configurable filtering to reduce amount of data collected that need to be sent for off system processing.

15. A non-transitory computer readable medium configured to store instructions for assigning attribution data to an application, wherein, when executed, the instructions cause a processor to perform the following:
implementing a set of custom instrumentation probes to collect data;
instrumenting the system at an operating system level based on implementing an instrumentation probe from said set of custom instrumentation probes;
receiving a subset of operating system, network, and application events data corresponding to a system in connection with the set of custom instrumentation probes;
generating a chain of responsibility process tree based on instrumenting the system at the operating system level and the collected data;
mapping corresponding operating system level process to a direct or indirect parent process that is assigned as an entry point for a logical application among a plurality of logical applications by implementing the chain of responsibility process tree; and
assigning, in response to mapping, attribution data to the logical application.

16. The non-transitory computer readable medium according to claim 15, wherein each of said logical applications has different and organizationally unrelated owners and implements dependent processes that carry out operation on behalf of a corresponding owner.

17. The non-transitory computer readable medium according to claim 16, wherein the attribution data corresponds to data that identifies an owner of the logical application in a way this is unique to each administration domain.

18. The non-transitory computer readable medium according to claim 15, when it is determined that a new process is scheduled, the instructions, when executed, cause the processor to further perform the following:
retrieving a tag for a parent process from the chain of responsibility process tree;
storing the tag indexed by the new process along with a tag identifier onto a memory; and
utilizing the tag identifier by accessing the memory to identify a corresponding application and determining what the system is processing.

19. The non-transitory computer readable medium according to claim 15, wherein the instructions, when executed, cause the processor to further perform the following:
detecting a behavior by monitoring the chain of responsibility process tree so that the behavior can be ascribed to a specific party responsible for the behavior; and
attributing any file access, network communication, and/or system call to the logical application that is responsible for the behavior.

20. The non-transitory computer readable medium according to claim 15, wherein the instructions, when executed, cause the processor to further perform the following:
identifying applications among the logical applications that are using cryptography;
automatically instrumenting the identified applications at the operating system level based on implementing the instrumentation probe from said set of custom instrumentation probes; and
automatically monitoring activities of the identified applications.
